(19) United States
(12) Patent Application Publication
(10) Pub. No.: US 2007/0198556 A1
(43) Pub. Date: Aug. 23, 2007

(54) Data unification models

(75) Inventors: Robert Alan Nist, Minneapolis, MN (US); Robert Bell, St. Paul, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Lawson Software, Inc.

(21) Appl. No.: 11/358,394

(22) Filed: Feb. 21, 2006

(51) Int. Cl. G06F 7/00

(52) U.S. Cl. 707/101

(57) ABSTRACT

The present subject matter relates to data access and, more particularly, to data unification models. Some embodiments provide systems, software, and methods of handling data access requests for data items having values stored in multiple instances across one or more data sources. Some embodiments provide a data manager to service access requests for a data item, wherein the data manager services the data access requests for the data item with data from an authoritative instance or from one of one or more secondary instances. In some embodiments, the data manager services the request for the data item according to a data model. The data model, in some embodiments, exists in metadata that is accessible to the data manager.

### TECHNICAL FIELD

The present subject matter relates to data access and, more particularly, to data unification models.

### BACKGROUND INFORMATION

Entities that maintain large volumes of data, such as corporations, commonly have multiple databases including multiple instances of the same data item. For example, multiple databases each including multiple instances of a customer name.

Having multiple instances of the same data item creates data consistency issues. For example, when one instance in a first database is updated, other instances in the first database also need to be updated and instances in other databases need to be updated as well. Another issue arises when an application or user accesses a data item that is maintained in multiple locations. The values in the multiple locations may not be identical. The application or user must then determine which value to use or always use the value from a certain location which could be out of date. Thus, in such instances where a data item is maintained in multiple locations, the source of truth for the value of the particular data item is not inherent from the data itself.

### BRIEF DESCRIPTION OF THE DRAWINGS

FIG. 1 is a logical schematic diagram according to an example embodiment.

FIG. 2 is a physical schematic diagram according to an example embodiment.

FIG. 3 is a block diagram of a method according to an example embodiment.

FIG. 4 is a block diagram of a method according to an example embodiment.

FIG. 5 is a logical schematic diagram of a metadata source according to an example embodiment.

FIG. 6 is a block diagram of a method according to an example embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software, or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Various embodiments of the present subject matter solve many of the problems created by having multiple instances of the same data item. Some embodiments provide a single consistent data model for corporate data to be shared among multiple data accessors. Metadata describing the data model identifies a single authoritative instance of a value of each data item in the model. Metadata describing the model also identifies other instances of the data item as secondary instances. In some embodiments, the identification of an authoritative instance can include rules, the application of which determine the authoritative instance differently depending on some other data value. Such metadata, in some embodiments, is maintained externally to the model, Data Manager, application, databases, and object. In various embodiments, a data source is a database table, a data item, an object, a file, or another data storage location or mechanism maintaining one or more data item instances.

As a result of embodiments of the present subject matter, data provided to data accessors is of a higher quality because an authoritative data item instance is identified for certain data items having multiple instances. Further, when differences are detected between an authoritative instance and a secondary instance of a data item, some embodiments automatically propagate the authoritative or most current value to the other data item instances. Some embodiments also enhance response time. Such embodiments allow lenient delivery of non-authoritative data item instances when the authoritative value is not available or to avoid performance overhead incurred in accessing data from more than one data source, such as from more than one application, object, database, table, or other data source. Further, some embodiments also provide data within a proper context to a data accessor, such as an application directed to a specific topic such as human resources. Data within the proper context is provided in such embodiments through the definition and use of perspectives.

In some embodiments, the metadata defines an authoritative instance and one or more secondary instances of one or more data items. The metadata of some such embodiments provides a description of the data items, the authoritative and secondary instances, and how to access the sources in which the data item instances are stored. The knowledge encompassed within the metadata is thus available regardless of the data access tool, system, application, or object used to access the data model described by the metadata. A Data Manager further provides a data access mechanism to translate access requests expressed against the model to be converted into equivalent requests against the applications, objects, databases, or other data storage mechanisms which maintain the data.

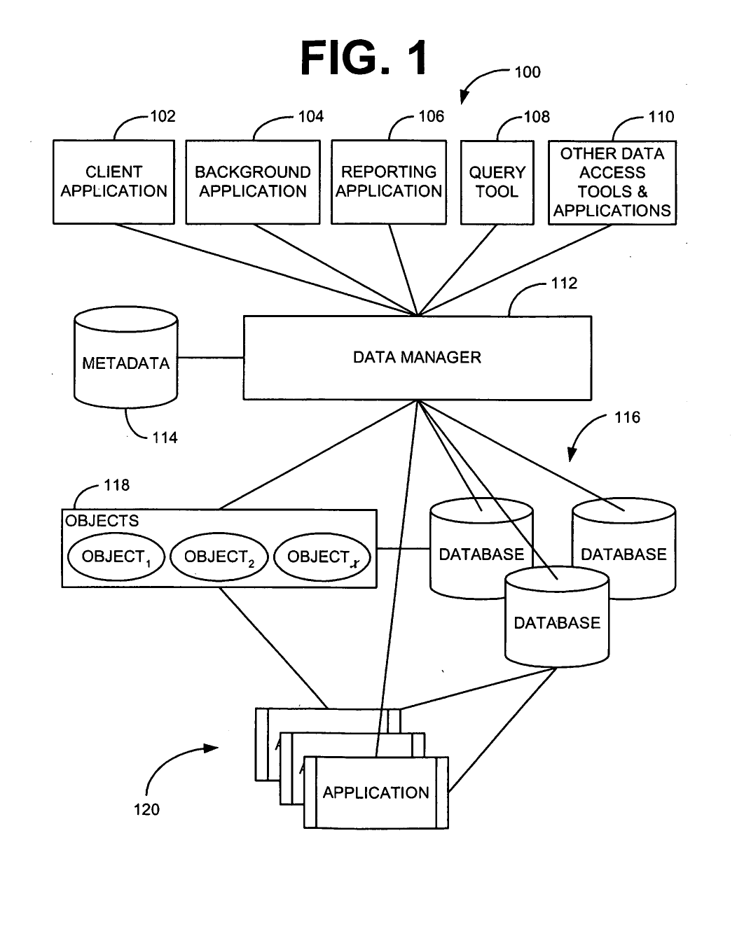

FIG. 1 is a logical schematic diagram 100 according to an example embodiment. The logical schematic diagram 100 illustrates logical relationships between data accessors and data storage mechanisms via a data manager 112 according to an example embodiment.

The data accessors can include a client application 102 that operates on a client computing device, a background application 104 that operates on a client computing device or a server and performs data processing jobs such as batch jobs, and a reporting application 106 that operates on a computing device for reporting purposes, such as a dashboard application. In some embodiments, the data accessors can also include a query tool 108 used to perform custom queries, updates, inserts, and deletes, and other data access tool and applications 110 depending on the particular embodiment of the system 100.

In some embodiments, the data storage mechanisms include one or more databases 116, objects 118, and applications 120. The one or more databases 116 can include one or more of relational database management systems, hierarchical databases, flat files, or other file or database systems that store data depending on the particular embodiment. The objects 118 can include one or more of business objects, application objects, or other objects that are keepers of data. In some embodiments, the objects 118 include business, data integrity, or other logic that is applied to the data stored therein or maintained by the objects 118 to enforce data rules. The applications 120 of some embodiments include applications 120 that maintain or store data. In some embodiments, the applications 120 include business, data integrity, or other logic that is applied to the data stored therein or maintained by the applications 120 to enforce data rules.

In some embodiments, the data sources, such as the one or more databases 116, the objects 118, and the applications 120, can include a data item maintained in multiple instances in the one or more data sources. In an example embodiment, the each instance of the data item is designated as either an authoritative instance of the data item or a secondary instance of the data item. In some embodiments, there is zero or one authoritative instance and zero or more secondary instances. In a case where there is no authoritative instance, the data manager 112 arbitrarily chooses a secondary instance to service a data access request. However, as described above, the authoritative instance can be determined as a function of one or more rules. The authoritative instance, in some embodiments, is the most up to date of the data item instances. The authoritative instance can be called a “source of truth” that can be relied upon by the data accessors when the most accurate value of the data item is needed.

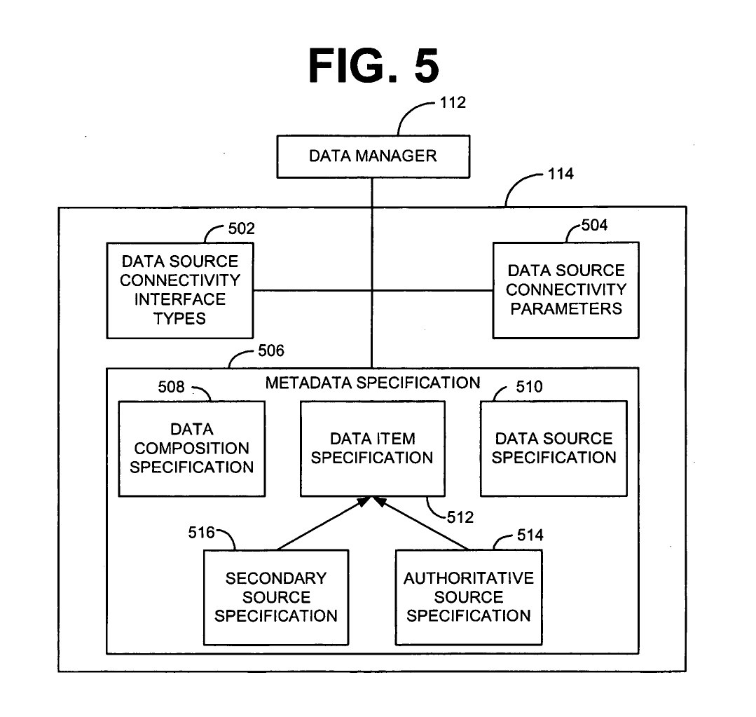

The data manager 112 in the system 100 operates to service access requests for the data item. A data access request can include one or more of a create, read, update, or delete data action. The data manager 112 services data accesses requests for the data item with data from the authoritative instance or from one of the one or more secondary instances. In some embodiments, the data manager 112 identifies a data item instance to service a data access request from based on metadata 114. The metadata 114, includes data describing data items and an authoritative and one or more secondary instances of the data items. In some embodiments, the metadata 114 is maintained in a database, such as a relational database. In other embodiments, the metadata 114 is available via a metadata object or other source depending on the specific embodiment. An example embodiment of a metadata 114 source is provided in FIG. 5 and described in greater detail below.

In operation, when the data manager 112 receives a data access request, including a request for a data item, the data manager 112 selects a data item instance from the authoritative and the secondary instances of the data item to service the data access request as a function of the metadata describing the data item. In some embodiments, this includes selecting the authoritative instance of the data item. In other embodiments, selecting a data item instance includes selecting a secondary instance of the data item if the authoritative instance is unavailable, such as when the data source is unavailable, e.g. due to failure. In other embodiments, the data manager 112 evaluates the data access request and selects a data item instance to service the data access request to reduce an amount of overhead associated with servicing the data access request. In one such embodiment, reducing the amount of overhead includes selecting a data item instance from the authoritative and secondary instance to reduce a number of data source joins, such as database table joins, needed to service the data access request.

In some embodiments, the data manager 112 receives a data access request for a plurality of data items including one or more data items which have multiple instances stored in one or more data sources. In this embodiment, the data manager 112 queries the metadata 114 to determine several things to service the data access request. The several things that need to be determined by the data manager 112 includes the various data sources of the requested data and how to join the data sources if there is more than one data source so the data can be synthesized into a single record. The data manager 112 also determines data source connectivity interfaces need, and connectivity parameters, to query the one or more data sources. The data manager 112 further determines an authoritative instance for each of the one or more data items stored in one or more data sources. Based on this determined information, the data manager 112 can then retrieve the requested data into a single synthesized record and service the data access request. In some embodiments, the single synthesized record can include multiple authoritative values where each authoritative value can come from a different data source.

In some embodiments, the metadata 114 further includes data defining one or more perspectives. A perspective, in some embodiments, tells the data manager 112 that when a certain data accessor, such as client application 102, submits a data access request for a particular data item, to service the data access request from a specific data source. The specific data source of a perspective can include an authoritative or secondary instance. In some embodiments, the specific data source of the perspective is always used by the data manager 112 in servicing the data access request for the particular data item from the certain data accessor. For example, if the client application 102 is a human resources application and the particular data item is “EMPLOYEE_ADDRESS,” the perspective tells the data manager 112 to always service “EMPLOYEE_ADDRESS” data access requests from the client application 102 with the data item instance stored in an “EMPLOYEE” table of a human resources database.

Thus, in some embodiments, a perspective definition in the metadata 114 includes a data accessor identifier and a data item instance identifier. When a data accessor requires a specific data item instance, a data access request from the data accessor includes an identifier of the data accessor identifier. The data manger 112 can then service the data access request from a particular data item instance identified in a perspective definition for the data accessor.

In some embodiments, such as the illustrated system 100, including various types of data sources, the data manager 112 accesses the data sources using data source access modules. A data source access module provides an interface between the data manager 112 and a data source type. Thus, in embodiments including multiple data source types, the data manager 112 includes, or has access to, a data access module for each data source type. In some embodiments, to facilitate the data manager's 112 use of the correct data source access module, the metadata 114 further includes data associating each data source holding data item instances with a data source type. The data manger 112 then uses the proper data access module to access data item instances within the particular data source.

In some embodiments, the data manager 112 further includes an update propagator. The update propagator identifies data access requests including an update request. The update propagator causes an update to one data item instance to be propagated to one or more other data item instances. In some embodiments, propagating an update to one or more other data item instances includes following data update rules defined in the metadata 114. A data update rule can specify when, and if, to propagate an update to other data item instances. For example, a data update rule can specify immediate update propagation to other data item instances. Other data update rules can specify propagating the update on a periodic basis, such as daily, or not to propagate the update to other instances.

In some embodiments, the data manager 112 further includes an update detector. The update detector compares values provided to service data access requests including an update request to determine if the secondary values match the authoritative value. The update propagator, in some embodiments, causes the value of the authoritative data item instance to be propagated to one or more other data item instances. In some embodiments, propagating a detected update to one or more other data item instances includes following data update rules defined in the metadata 114. A data update rule can specify when, and if, to propagate a detected update to other data item instances. For example, a data update rule can specify immediate detected update propagation to other data item instances. Other data update rules can specify propagating the detected update on a periodic basis, such as daily, or not to propagate the detected update to other instances.

In some embodiments, data update requests are passed by the data manager 112 to one or more objects 118 or applications 120 as determined by the data manager 112. The objects or applications receiving the update request from the data manager, in some embodiments, then apply rules to the update request. The rules can include business logic, data integrity rules, or other rules depending on the particular embodiment. If the rules are applied successfully, the update request can be committed. If the rules are applied unsuccessfully, the object or application can choose, based on its logic how to proceed. This can include a rollback of the update request to prevent the update request from altering stored data. The object or application in such an instance can return an error message to the data manager 112 which then can pass then message back to the origin of the update request.

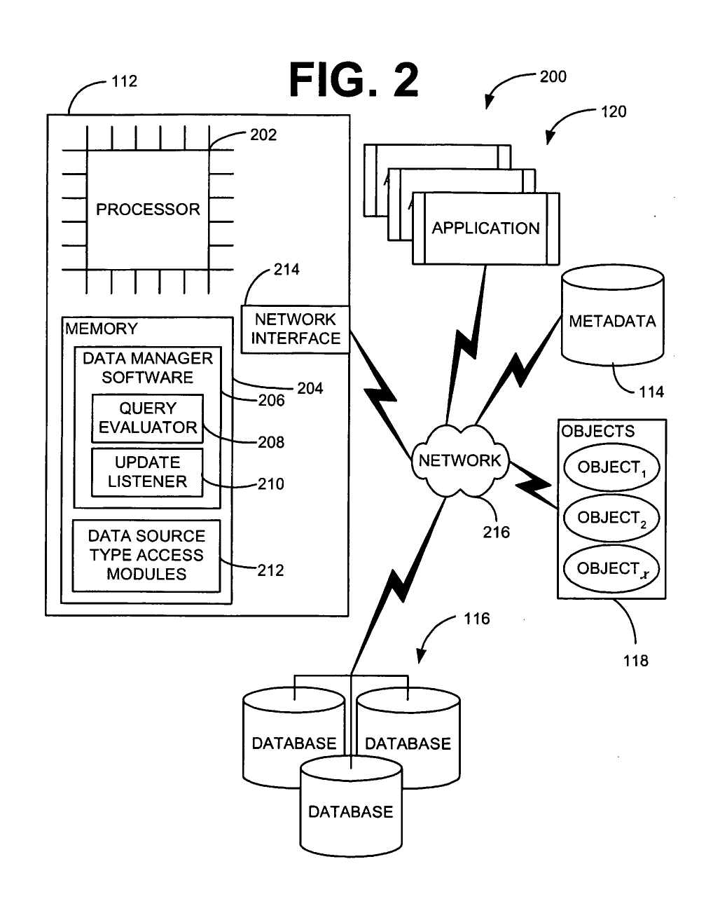

While FIG. 1 illustrates logical relationships between data accessors and data storage mechanisms via the data manager 112 according to an example embodiment, FIG. 2 provides a physical schematic diagram according to an another example embodiment. FIG. 2 illustrates interconnections between the data manager 112, the metadata 114, and the data sources via a network 216. Although not illustrated in FIG. 2, the data accessors 102, 104, 106, 108 and 110, if illustrated would be interconnected to the system 200 via the network 216 or to the data manager 112 via another network.

The data manager 112 is a data processing device, such as a computer. The data manager 112 includes a processor 202, a memory 204, and a network interface 214.

In one embodiment, multiple such data processing devices are utilized in a distributed network to implement the data manager 112. An object oriented architecture can be used to implement such functions and communicate between the data processing devices and components. One example data processing device is in the form of a computer and can include a processing unit, such as a processor 202, a memory 204, removable storage, and non-removable storage. Memory 204 can include volatile memory and non-volatile memory. The data processing device can include—or have access to a computing environment that includes—a variety of machine-readable media, such as volatile memory and non-volatile memory, removable storage and non-removable storage. Storage can include random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. The data processing device can include or have access to a computing environment that includes input, output, and one or more communication connections, such as network interface 214. The data processing device can operate in a networked environment, such as on the network 216, using a communication connection to connect to one or more remote data processing devices, such as databases 116 on database server and applications 120 and objects 118 that operate on remote data processing devices. The remote data processing devices can include a personal computer (PC), server, router, network PC, a peer device or other common network node, or the like. The network 216 can include one or more of a Local Area Network (LAN), a Wide Area Network (WAN), a System Area Network (SAN), the Internet, or other networks.

Computer-readable instructions stored on a machine-readable medium are executable by the processor 202 of the data manager 112. A hard drive, CD-ROM, and RAM are some examples of articles including a machine-readable medium. The term “machine readable medium” is also used to represent carrier waves on which software is transmitted. For example, a program capable of providing a generic technique to perform access control check for data access and/or for doing an operation on one of the servers in a component object model (COM) based system according to the teachings of the present invention may be included on a CD-ROM and loaded from the CD-ROM to a hard drive. The machine-readable instructions allow data manager 112 to provide generic access controls in a COM based computer network system having multiple users and servers.

The memory 204 of the data manager 112 includes machine-readable instructions stored thereon. The machine-readable instructions include data manager software 206 and data source type access modules 212.

The data manager software 206 includes a query evaluator 208 and an update listener 210. The query evaluator 206 receives and services data access requests, such as create, read, update, and delete access requests, via the network interface 214 over the network 216 to one or more of the data sources. In some embodiments, the query evaluator 208 services a data access request by identifying data item instances to service the data access request as a function of the metadata 114 and services the data access request with data items from or to the identified data item instances.

However, some data access requests include a request for several data items, one or more of which is for a specific data item instance, regardless of authoritative instance and one or more secondary sources identified in the metadata 114. The query evaluator 208 services such specific data item requests with the specified instance of the data item, while utilizing metadata 114 to identify sources to service other data items requested within the data access request.

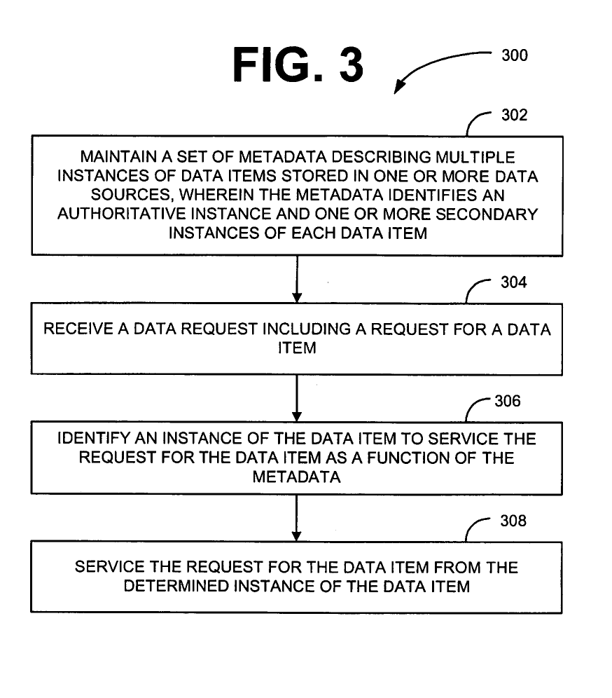

FIG. 3 is a block diagram of a method 300 according to an example embodiment. The example method 300 embodiment includes maintaining a set of metadata describing multiple instances of data items stored in one or more data sources 302. In some such embodiments, the metadata identifies an authoritative instance and one or more secondary instances of each data item 302. The method 300 further includes receiving a data request including a request for a data item 304, identifying an instance of the data item to service the request for the data item as a function of the metadata 306, and servicing the request for the data item from the determined instance of the data item 308.

In some embodiments, the method 300 also includes synthesizing a record from multiple data sources including the multiple instance of the data item in response to the received data request 304. This synthesized record, in some embodiments includes at least a portion of the metadata identifying the authoritative and secondary instances of the data item. The metadata of the synthesized record is used to identify the instance of the data item to service the request for the data item 306.

In some embodiments of the method 300, the metadata further defines one or more perspectives. A perspective definition, in some embodiments, includes a data accessor identifier, such as a specific application that accesses data, and a data item instance identifier, such as a specific column in a database table. In some such embodiments of the method 300, identifying an instance of the data item to service a request for a data item as a function of the metadata 306 includes identifying the data item instance of the perspective definition when the requested data item and the data accessor identifier is the same as the perspective definition.

In some further embodiments of the method 300, identifying an instance of the data item to service a request for a data item as a function of the metadata 306 includes identifying a secondary instance of the data item if the authoritative instance is not available. In other embodiments, identifying an instance of the data item to service a request for a data item as a function of the metadata 306 includes identifying a data item instance from the authoritative and secondary instances of the data item that reduces a number of data source operations, such as database table joins, necessary to service the data request.

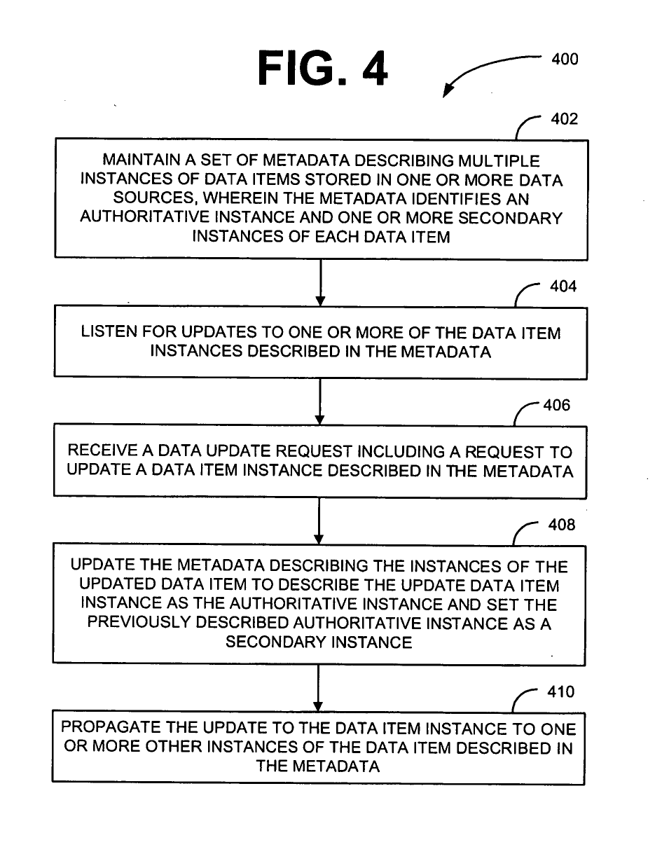

FIG. 4 is a block diagram of a method 400 according to an example embodiment. The example method 400 embodiment includes maintaining a set of metadata describing multiple instances of data items stored in one or more data sources 402. In some such embodiments, the metadata identifies an authoritative instance and one or more secondary instances of each data item. The method 400 further includes listening for updates to one or more of the data item instances described in the metadata 404 and receiving a data update request including a request to update a data item instance described in the metadata 406. Some embodiments of the method 400 also include updating the metadata describing the instances of the updated data item to describe the update data item instance as the authoritative instance and set the previously described authoritative instance as a secondary instance 408. Some embodiments include propagating the update to the data item instance to one or more other instances of the data item described in the metadata 410.

In some such embodiments, the data source of the data item instance is an object or application. The object or application can apply one or more rules to the update request prior to committing the update request. The one or more rules can include data integrity rules, business rules, data access permission or security rules, or other rules or logic of objects or applications.

FIG. 5 is a logical schematic diagram of a metadata 114 source according to an example embodiment. The example embodiment of the metadata 114 source includes metadata stored in a manner to make the data available to the data manager 112, such as the data manager 112 illustrated in FIG. 1 and described above. The metadata includes data identifying data source connectivity interface types 502, data source connectivity parameters 504, and metadata specifications 506.

The data source connectivity interface types 502 data includes data identifying one or more connectivity interfaces available to the data manager 112 to use in connecting to data sources. These interface types can include data base connectivity interfaces such as Object and Java Database Connectivity (ODBC and JDBC) interfaces, application programming interfaces (APIs) of one or more applications or objects, file format specifications, or other interfaces useful in communicating with a data source for exchanging data or other information.

The data source connectivity parameters 504 data includes data specifying parameters needed to connect to one or more data sources. These parameters can include parameters to provide to an ODBC or JDBC interface to establish a database connection. These parameters can also include parameters for other interface types identified in the data source connectivity interface types 502 data.

The metadata specifications 506 includes data describing data stored in one or more data sources. This data includes data source specifications 510, data composition specifications 508, and data item specifications 512.

The data source specifications 510 identify one or more data sources. These data sources can include database tables, applications, objects, files, and other data source types. The data source specifications can further identify where the data source is, such as within a database, where a file is stored, or an address, or other identifier, at which to access a file, object, application, or other data source.

The data composition specifications 508 provides data to the data manager 112 to use in merging records from two or more data sources. An example of a data composition specification identifies two database tables, or other data sources, having records that can be merged and columns on which to match keys.

The data item specifications 512 identifies multiple instances of the same data item that is stored in one or more data sources. The data item specifications 512 are further augmented with authoritative instance specifications 514 and secondary instance specifications 516. The authoritative instance specifications 514 identify the authoritative instances of the multiple instances of data items. The secondary instance specifications identify the alternative sources of the multiple instance of data items.

In some embodiments, the metadata 114 is in an eXtensible Markup Language (XML) document. In other embodiments, the metadata 114 is stored in one, or a series of, database tables.

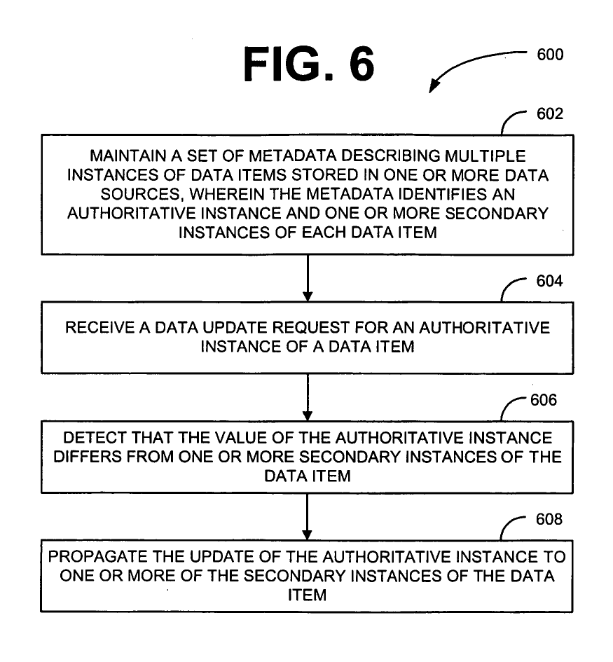

FIG. 6 is a block diagram of a method 600 according to an example embodiment. This embodiments of the example method 600 includes maintaining a set of metadata describing multiple instances of data items stored in one or more data sources, wherein the metadata identifies an authoritative instance and one or more secondary instances of each data item 602. The method 600 furhter includes receiving a data update request for an authoritative instance of a data item 604 and detecting that the value of the authoritative instance differs from one or more secondary instances of the data item 606. After detecting the differing values, the method 600 includes propagating the update of the authoritative instance to one or more of the secondary instances of the data item 608.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A system comprising:
one or more data sources, wherein:
the one or more data sources include a data item maintained in multiple instances in the one or more data sources, and
the multiple instances of the data item includes an authoritative instance and one or more secondary instances; and
a data manager to service access requests for a record including the data item, wherein the data manager services the data accesses requests for the data item by synthesizing a record from multiple authoritative data items.

2. The system of claim 1, further comprising:
a metadata database including data describing the data item and identifies the authoritative and the one or more secondary instances of the data item;
wherein the data manager, upon receipt of an access request for the data item, selects a data item instance from the authoritative and the secondary instances of the data item to service the data access request as a function of the metadata describing the data item.

3. The system of claim 2, wherein if the data item instance to service the data access request is unavailable, the data manager selects another data item instance to service the data request.

4. The system of claim 2, wherein the data manager selects a data item instance from the authoritative and the secondary instances of the data item to reduce a number joins of the one or more data sources needed to service the data access request.

5. The system of claim 2, wherein:
the metadata database further includes data defining one or more perspectives,
a perspective definition includes a data accessor identifier and a data item instance identifier,
a data access request received by the data manager includes a data accessor identifier, and
the data manager services the data access request from a data item instance identified in a perspective definition selected by the data manager using the data accessor identifier of the data access request.

6. The system of claim 5, wherein the data accessor is an application.

7. The system of claim 2, wherein the metadata database further includes data associating a data source type of the data source in which each data item instance is stored, and the system further including:
a data source access module for each data source type, wherein access to a data item instance is routed to a data source access module of the data source type associated with the data item instance in the metadata.

8. The system of claim 1, wherein the access requests for the data item include a data item update request.

9. The system of claim 8, wherein the data manager includes an update listener to cause an update to one instance of the data item to be propagated to one or more of the other data item instances.

10. A system of claim 1, wherein at least one of the one or more data sources is an object.

11. The system of claim 10, wherein an update to one or more of the data item instances includes an update to the at least one object, wherein the update to the at least one object causes the at least one object to apply a business rule to ensure data integrity prior to committing the update request.

12. The system of claim 1, wherein at least one of the one or more data sources is a database.

13. A method comprising:
maintaining a set of metadata describing multiple instances of data items stored in one or more data sources, wherein the metadata identifies an authoritative instance and one or more secondary instances of each data item;
receiving a data request including a request for a data item;
identifying an instance of the data item to service the request for the data item as a function of the metadata; and
servicing the request for the data item from the determined instance of the data item.

14. The method of claim 13, wherein the metadata further defines one or more perspective, wherein:
a perspective definition includes a data accessor identifier and a data item instance identifier, and
identifying an instance of the data item to service the request for the data item as a function of the metadata includes identifying the data item instance of the perspective definition when the requested data item and the data accessor identifier is the same as the perspective definition.

15. The method of claim 14, wherein the data accessor identifier is an identifier of an application that requests data from the one or more data sources.

16. The method of claim 13, wherein identifying an instance of the data item to service the request for the data item as a function of the metadata includes identifying the authoritative instance of the requested data item.

17. The method of claim 13, wherein identifying an instance of the data item to service the request for the data item as a function of the metadata includes identifying a secondary instance of the data item if the authoritative instance is not available.

18. The method of claim 13, wherein identifying an instance of the data item to service the request for the data item as a function of the metadata includes identifying a data item instance from the authoritative and secondary instances of the data item that reduces a number of data source operations necessary to service the data request.

19. The method of claim 18, wherein the data source operations include database table joins.

20. A method comprising:
maintaining a set of metadata describing multiple instances of data items stored in one or more data sources, wherein the metadata identifies an authoritative instance and one or more secondary instances of each data item;
listening for updates to one or more of the data item instances described in the metadata;
receiving a data update request including a request to update a data item instance described in the metadata; and
updating the metadata describing the instances of the updated data item to describe the updated data item instance as the authoritative instance and set the previously described authoritative instance as a secondary instance.

21. The method of claim 20, further comprising:
propagating the update to the data item instance to one or more other instances of the data item described in the metadata.

22. The method of claim 20, wherein the data source of the data item instance is an object.

23. The method of claim 22, wherein the object applies one or more rules to the update request prior to committing the update request.

24. The method of claim 23, wherein the one or more rules include a business rule.

25. A machine-readable medium, with instructions encoded thereon that when processed, result in the machine:
maintaining a set of metadata describing multiple instances of data items stored in one or more data sources, wherein the metadata identifies an authoritative instance and one or more secondary instances of each data item;
receiving a data update request for an authoritative instance of a data item;
detecting that the value of the authoritative instance differs from one or more secondary instances of the data item; and
propagating the update of the authoritative instance to one or more of the secondary instances of the data item.

26. The machine-readable medium of claim 26, wherein the data update request is for a specific data item instance.

27. The machine-readable medium of claim 26, wherein:
the data source of the specific data item instance is an object; and
the object applies one or more business rules prior to committing the update request.
